(19) United States
(12) Patent Application Publication
(10) Pub. No.: US 2006/0265152 A1
(43) Pub. Date: Nov. 23, 2006

(54) Level measurement device operating under stored program control and including a program update module mechanism

(76) Inventors: Graham D. Wall, Peterborough (CA); Dominique F. Basson, Peterborough (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/121,266

(22) Filed: May 3, 2005

(51) Int. Cl. G06F 19/00

(52) U.S. Cl. 702/55

(57) ABSTRACT

A level measurement apparatus for determining the level of a material received in a container. The level measurement apparatus operates under stored program control and includes a mechanism for upgrading the program or program components. The program is updated by downloading one or more code segments to the level measurement apparatus and writing the code segment to the program stored in memory. The code segment is formatted into a code block for downloading. The code block comprises a header and a code section. The header includes at least a memory indicator and the code section contains the executable code for the code segment. The header may further include another data field for identifying other code segments associated with the specified code segment and whether the associated code segments need to be downloaded.

### FIELD OF THE INVENTION

The present invention relates to level measurement devices, and more particularly to a level measurement system operating under stored program control and having a mechanism for upgrading or updating a program module or code component.

### BACKGROUND OF THE INVENTION

Pulse-echo ranging systems, also known as time-of-flight ranging systems, are commonly used in level sensing and level measurement applications. Pulse-echo ranging systems determine the distance to a reflective surface (i.e. reflector) by measuring how long after transmission of a burst of energy pulses the echoes or reflected pulses are received. Pulse-echo ranging systems typically use ultrasonic pulses or pulse radar or microwave signals.

Pulse-echo ranging systems are commonly used to measure the level of material within a vessel or container. These systems include a level measurement device or device comprising a housing and a waveguide such as a rod or a horn antenna, or in an ultrasonic implementation, an ultrasonic transducer. The level sensing or measurement device is typically mounted to the top of a vessel containing a material to be measured with the antenna (or transducer) extending into the interior of the vessel.

The level sensing or measurement device includes electronics and circuitry for transmitting and receiving the pulses, calculating the time elapsed between transmission and reception of the pulses, and determining the distance to the surface of the material. The electronics typically include a controller implemented using a microprocessor or microcontroller. The microprocessor operates under stored program control. The program is stored as firmware in non-volatile memory, for example, ROM (Read Only Memory), PROM (Programmable Read Only Memory), EEPROM (Electrically Erasable Programmable Read Only Memory) or Flash memory. The program memory (i.e. chips) are installed at the time of manufacture on a printed circuit board together with the microprocessor and the remainder of the electronic circuitry.

The program includes functions for controlling the circuitry to transmit and receive pulses, processing the received pulses and generating an echo profile, calculating the level measurement utilizing the echo profile, controlling a current loop (e.g. 4 to 20 mA) interface, performing power management, providing a communication interface, providing a user interface (i.e. keypad scan and LCD display functions), controlling and other known functions or operations in the level measurement art. To provide flexibility, the program typically includes the capability to configure one or more user parameters between preset or predefined program parameters.

As such the program or firmware for a level measurement application is a complex and intricate piece of software with one or more complicated algorithms operating alone or in combination. The development and support of the firmware is lengthy and involves considerable effort for verification and acceptance testing. Even with the most extensive testing procedures, there will be market forces which will dictate a launch date, and any subsequently discovered bugs cannot be fixed without changing the program. Similarly, any enhancements or upgrades to the program cannot be implemented without changing the program or program modules. Because the program functions and features are programmed in firmware and stored in a memory chip, a change to any of the functions or features requires replacement of the memory chip(s) in the level measurement device. This typically means a costly replacement or upgrade in the field.

Accordingly, there remains a need for improvements in the field of level measurement devices which address these deficiencies and provide the capability to facilitate the upgrading or updating of programs and/or firmware components.

### SUMMARY OF THE INVENTION

The present invention provides a level measurement apparatus operating under stored program control and having a mechanism for upgrading or updating a program module or code component.

In a first aspect, the present invention provides a level measurement apparatus for determining the level of a material in a container, the apparatus comprises: an antenna for emitting energy pulses and coupling energy pulses reflected by the material; a controller having a transmit module operably coupled to the antenna and a receiver module operably coupled to the antenna for receiving the coupled energy pulses; the controller operating under the control of a program stored in memory, the memory is operably coupled to the controller; the program comprises a plurality of code components including a code component for controlling the transmit module, a code component for controlling the receiver module and a code component for determining the level of the material based on the reflected pulses; and a program update module for updating any one of the code components.

In a second aspect, the present invention provides a method for updating a code segment in a program stored in memory for a level measurement apparatus for determining the level of a material received in a container, the method comprises the steps of: determining a code segment to be updated; formatting the code segment for downloading to the level measurement apparatus; receiving the code segment at the level measurement apparatus; determining a memory location for the code segment; writing the code segment in the program at the memory location in the memory.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Reference is next made to the accompanying drawings which show, by way of example, embodiments of the present invention and in which:

FIG. 1 shows in diagrammatic form a level measurement system having a program update mechanism according to the present invention and configured for a loop powered application or operation.

FIG. 2 is a schematic diagram of a level measurement device having a program update mechanism according to the present invention;

FIG. 3 is a schematic diagram of a memory map for the program module for the level measurement device of FIG. 1;

FIG. 4 is a schematic diagram of an upgradeable program block according to one aspect of the present invention; and

FIG. 5 is a flowchart showing a method for upgrading a program component in accordance with another aspect of the present invention.

In the drawings, like references indicate like or similar components or elements.

### DETAILED DESCRIPTION OF EMBODIMENTS OF THE INVENTION

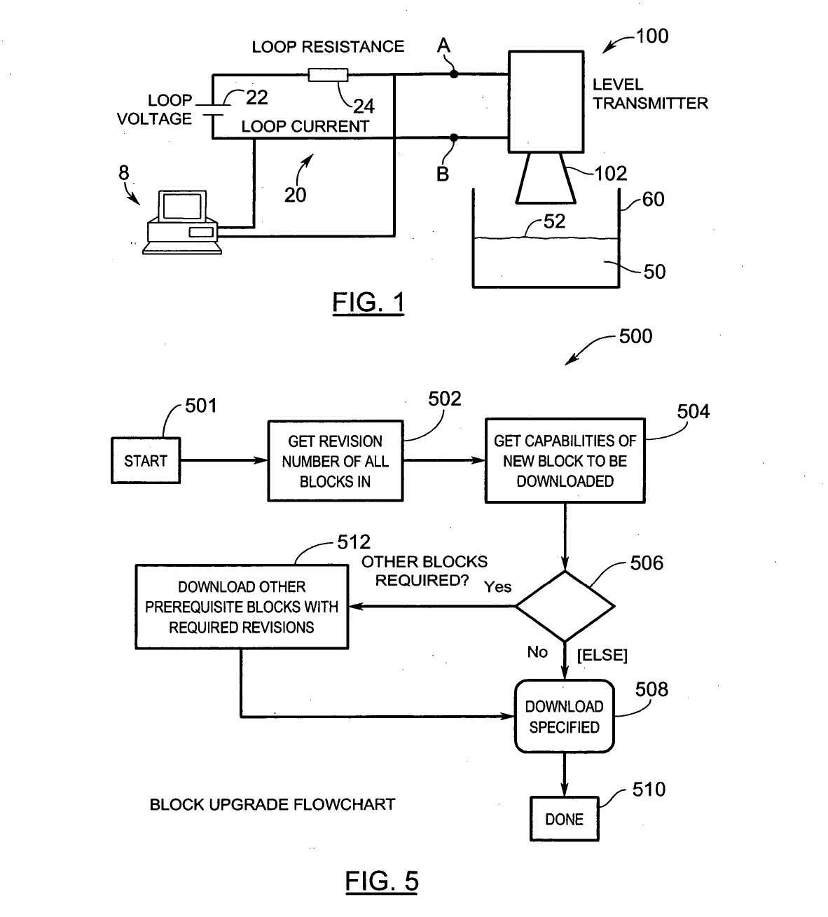

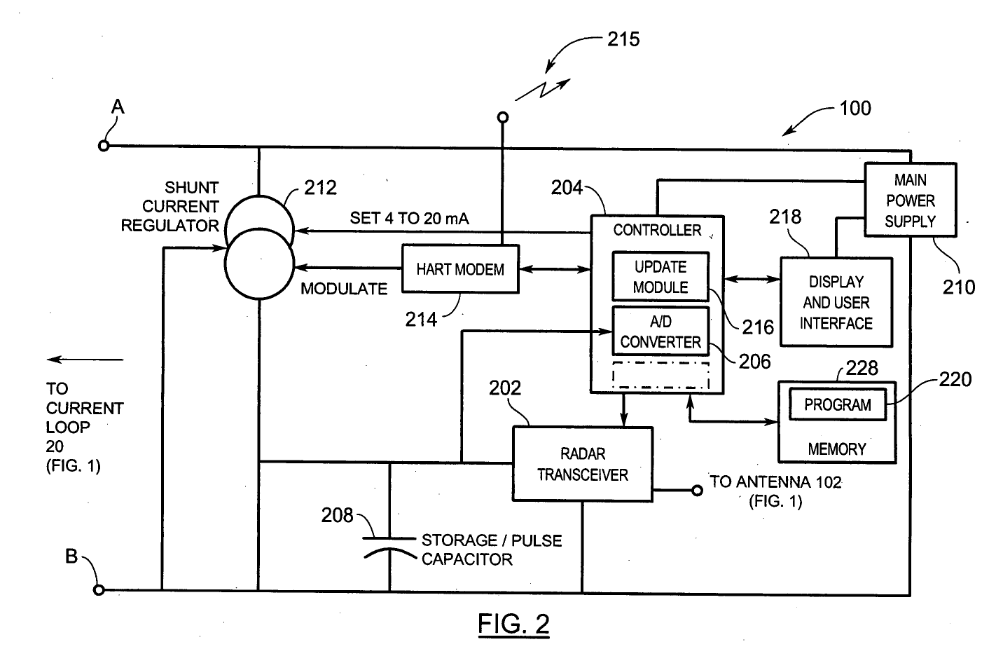

Reference is first made to FIG. 1, which shows in schematic form a level measurement device or apparatus with a program update or upgrade mechanism in accordance with the present invention and indicated generally by the reference 100. While the level measurement device or apparatus 100 is described in the context of pulse radar based ranging or time of flight ranging system, it will be understood that the level measurement device and upgradeable program mechanism is applicable to acoustic or ultrasonic based pulse-echo ranging device and guided wave radar time domain reflectometry or TDR based systems.

The level measurement device 100 is configured for loop powered operation and as shown in FIG. 1, the device 100 interfaces to a power/communication loop 20, for example, a 4-20 mA current loop. The level measurement device 100 is coupled to the current loop 20 at terminals A and B. A remote receiver, for example, a plant control computer, indicated by reference 8 is coupled at the other end of the current loop 20. For a typical 4-20 mA current loop configuration, the loop 20 provides a current in the range of 4 to 20 mA and a loop voltage in the range 18 to 30 Volts. The loop voltage is nominally at 24 Volts and represented as a voltage source with reference 22. The resistance of the loop is represented as a resistive element 24 and is typically in the range 0 to 550 Ohms. While the loop current is normally in the range 4 to 20 mA, the current may range from 3.6 to 21.6 mA. It will be appreciated that the level measurement device 100 is suitable for non-loop powered and other configurations.

Reference is next made to FIG. 2, which shows in more detail the level measurement device 100 with a program update or upgrade mechanism according to the invention. As shown, the level measurement device 100 comprises a radar transceiver 202 (i.e. a horn antenna 102 as shown in FIG. 1, and transmit circuit and receive circuit), a microprocessor or controller unit 204, an analog-to-digital converter (ADC or A/D converter) 206, a storage or pulse capacitor 208 (i.e. for pulsing the radar antenna 102), a main power supply module 210, a current loop (4-20 mA) interface module 212, a communication module 214, a program upgrade or update module indicated generally by reference 216, and a display and user interface 218. The current loop interface 212 may be implemented, for example, as a shunt current regulator which is coupled to an output port on the controller 204 and operated under the program control. For an ultrasonic implementation, the radar transceiver 202 is replaced with an ultrasonic transducer and appropriate transmit and receive circuitry for coupling the transducer to the microprocessor 204.

The controller 204 (i.e. implemented as a microprocessor or microcontroller) operates under the control of a program 220, for example, stored in the form of firmware in a memory device 228. The program 220 comprises a plurality of code components or modules (i.e. software or code means) which implement or provide the functions or functionality associated with the operation of the level measurement device 100 and the operation of the program update module 216 as described in more detail below.

The controller 204 executes a code component to generate a transmit pulse control signal for the radar transceiver 202, and the radar antenna 102 (e.g. the horn antenna, or a rod antenna) emits a transmit burst of energy, i.e. radar pulses directed at the surface of a material 10 (FIG. 1) contained in the storage container or vessel 20 (FIG. 1). The reflected or echo pulses, i.e. the propagated transmit pulses reflected by the surface 12 of the material 10 (FIG. 1), are coupled by the radar antenna 102 (FIG. 1) and converted into electrical signals by the transceiver module 202. The electrical signals are inputted by the controller 204 and sampled and digitized by the A/D converter 206 and a code component executed by the controller 204 generates a receive echo waveform or profile. The controller 204 executes an algorithm (i.e. a code component) which identifies and verifies the echo pulse and calculates the range, i.e. the distance to the surface 12 (i.e. reflector), from the time it takes for the reflected energy pulse to travel from the reflective surface 12 (FIG. 1) to the antenna 102 (FIG. 1). From this calculation, the distance to the surface 12 of the material 10, and thereby the level of the material 10 in the vessel 20, is calculated or determined. The controller 204 comprises a microprocessor or a microcontroller with “on-chip” resources, such as program memory (e.g. EEPROM or NVRAM), RAM, i.e. the memory device 228, a serial communication (e.g. modem) interface, i.e. the communication module 214, and the A/D converter 206.

The program 220 also includes a code component, i.e. a function or algorithm for controlling the transmission of data and control signals through the current loop interface 212. The controller 204 uses the interface 212 (i.e. the shunt current regulator) to adjust or modulate the loop current in the range 4 mA to 20 mA to transmit the calculated level of the material 10 to the remote receiver or plant computer 8 (FIG. 1).

The communication module 214 comprises a digital communication modem, for example a HART modem, which provides a communication channel between the controller 204 and the remote computer or controller 8 (FIG. 1) over the wires of the current loop 20 (FIG. 1). The program 220 includes a code component for controlling the operation of the communication module 214, i.e. the transmission and reception of data over the communication channel. In another embodiment, the communication module is implemented or augmented with a wireless channel 215. As will be described in more detail below, the program upgrade module 116 utilizes the communication module 114 to download and/or upgrade the program modules or code component(s). The downloaded program modules are then written to the program 220 stored in memory 228 according to a memory map as described in more detail below. The program update module 216 may also be implemented as a code component executed by the controller 204 and in operation with downloading of program modules.

In a block-oriented fieldbus implementation, e.g. a Profibus Profile 3.0 device, for the level measurement system 100. The functionality for the program 220 is partitioned or structured into self-contained software modules, code blocks or code segments.

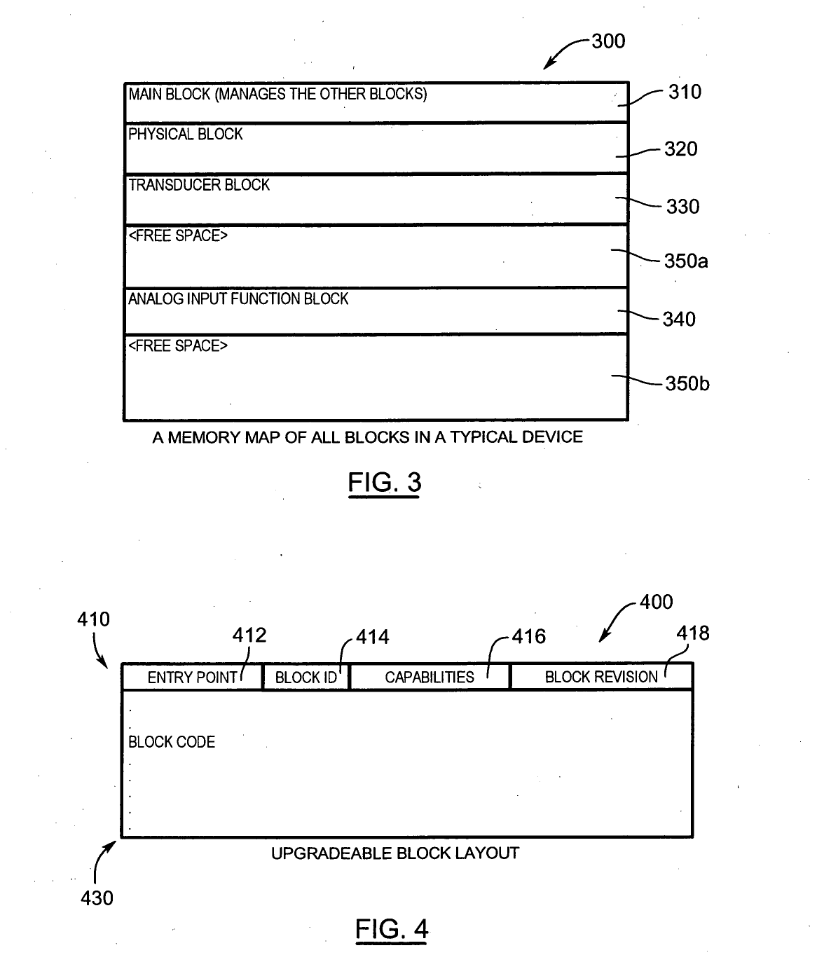

Reference is next made to FIG. 3, which shows a memory map configuration 300 for the program 220 (FIG. 2) stored in memory 228 (FIG. 2). As shown in FIG. 3, the program modules or blocks comprise a main block 310, a physical block 320, a transducer block 330, and an analog input function block 340. As shown in FIG. 3, the memory map 300 may also include one or more free memory blocks 350, indicated individually by references 350a, 350b. The free memory blocks 350 may be the same size or a multiple of the size of the corresponding program function block, for example, if the transducer block 330 is 500 KiloBytes, the free memory block 350a may also be 500 KB or twice as large at 1 Meg.

The main block 310 comprises the code for managing the other blocks and may be implemented as the main loop in the firmware. The physical block 320 comprises code containing information about the device 100 for example, its name, hardware and software revision, diagnostic information. The transducer block 330 comprises the functions for controlling the radar transceiver 202 (FIG. 2) and the antenna 102 (FIG. 1) or ultrasonic transducer. The transducer block 330 includes, for example, code for controlling the transmitter stage 208 (FIG. 2) and the receiver module 210 (FIG. 2) and code for processing the received echo signal, and for instance, code for generating a receive echo profile. The analog input function block 340 comprises the functions or routines for controlling the output data of the device, and includes functions for linearization, scaling and filtering of the transducer block values, and may also include failsafe handling. The free memory blocks 350 provide space in memory for additional or future functional blocks to be developed and/or downloaded at a later time. Or alternatively, the free memory blocks 350, for example, 350b allow the analog input function block 340 to be redesigned or rewritten beyond the original size of the block 340. Similarly, the free memory block 350a allows the code for the transducer block 330 to be expanded beyond the original size of the block 330.

Reference is next made to FIG. 4, which shows a block layout or structure for an upgradeable program block or code segment 400 according to another aspect of the invention. As shown in FIG. 4, the upgradeable block or unit 400 comprises a header section 410 and a code section or block indicated by reference 420. The header section 410 comprises an entry point field 412, a block ID field 414, a capabilities field 416, and a block revision field 418. The code block 420 comprises the code (e.g. code segment(s) or firmware) which is executed by the microprocessor (i.e. the controller 204).

Referring still to FIG. 4, the entry point field 412 comprises a memory address or indirect memory address (i.e. a pointer to a memory address). The entry point 412 indicates the first location that the processor (e.g. the CPU (central processing unit) or microprocessor) jumps to begin executing code in the associated block. The block ID 414 comprises a field that identifies the type of block, and is used by the program upgrade module 116. For example, the physical block 320 is identified by “1” in block ID field 414, the transducer block 330 is identified by “2” in the block ID field 414, the analog input function block 340 is identified by “3”, in the block ID field 414. Similarly, the free memory blocks 350 may be each uniquely identified in the block ID field 414, for example “4” for the first free memory block 350a and “5” for the second free memory block 350b, or the free memory blocks 350 by identified by a generic block ID code.

Referring again to FIG. 4, the capabilities field 416 comprises a number of bits that are utilized by the program upgrade module 216 to determine if other program or code blocks for a particular version or release of the program 220 (FIG. 2) are needed to operate with the code block that is to be updated. For example, if the memory range for the program 220 was expanded, then the new or upgraded transducer block 330 may require a newer version of the physical block 320 that is able to handle the expanded memory range.

The block revision field 418 includes information about the revision or version history for the associated block. This information is used by the program upgrade module 216 (FIG. 2).

Reference is next made to FIG. 5, which shows in flowchart form a code block upgrade process or method according to another aspect of the invention and indicated generally by reference 500. The process steps are implemented in the firmware or code components executed by the microprocessor, for example, in the program upgrade component or module 216 (FIG. 2). The upgrade block process 500 begins at step 501. The upgrade process 500 is initiated by an external input or an internal input. The external input is generated, for example, by the plant computer 8 (FIG. 1) or another remote device (not shown), which initiates the program upgrade (i.e. download) and depending on the particular implementation also provides the code segment(s) to be downloaded to the device 100. The external input may also include a user entry via the display and user interface 218 (FIG. 2), which then results in a code component (for example, as part of the program update module 216) querying the remote computer 8 for any program updates. The internal input is generated internally to the device 100, for example, as part of scheduled maintenance event or as a result of a self-diagnostics check. The first operation comprises getting the revision number of all the blocks in the program 220 (FIG. 2) as indicated by step 502. As described above, the revision number for the program block is found or stored in the block revision field 418 of the header section 410 (FIG. 4). The next operation at step 504 comprises getting the capabilities information from the capabilities field 416 (FIG. 4). Next at decision step 506, the program upgrade or update module 216 (FIG. 2) determines if there are any additional program modules or code blocks/segments to be downloaded. If no, the program block is downloaded at step 508 and the upgrade process is ended at step 510. On the other hand, if other code blocks are required as determined at step 506, then these prerequisite blocks with the required revision data are downloaded or queued for downloading at step 512. The program block or code segment is downloaded from a control device, for example the computer 8 (FIG. 1) operating under suitable program control, to the level measurement device 100 (FIG. 1) using the communication interface 214 (FIG. 2) and the current loop 20 (FIG. 1) or a separate communication channel, either wireless or hardwire. The downloaded program block(s) or code segment(s) are then written to or stored in the memory for the program 220 (FIG. 2). This function may be implemented in the program 220 (FIG. 2) as a code component which is executed by the controller 204 (FIG. 2).

For the upgrade block process 500 described above with reference to FIG. 5, the program 220 (FIG. 2) may be implemented with fixed addresses for each code block in the memory map 300 in FIG. 3. The addresses for the block segments or block boundaries are selected to provide enough free memory for future block upgrades and expansion.

The memory map 300 (FIG. 3) may also be implemented with a file management structure to allow the updated program segments or code blocks to be relocated in the program memory, for example, if the more memory space is needed than first allocated for the original code block. The upgrade program process 500 is modified to include the additional processing needed to locate the program or code blocks in memory.

While described in the context of an ultrasonic pulse, radar pulse or microwave based time-of-flight or level measurement application, the apparatus and techniques according to the present invention also find application in a FMCW radar level transmitter system. FMCW radar level transmitter systems transmit a continuous signal during the measurement process. The frequency of the signal increases or decreases linearly with time so that when the signal has travelled to the reflective surface and back, the received signal is at a different frequency to the transmitted signal. The frequency difference is proportional to the time delay and to the rate at which the transmitted frequency was changing. To determine the distance that the reflector is away from the radar transmitter, it is necessary to analyze the relative change of the received signal with respect to the transmitted signal as will be appreciated by those skilled in the art.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather the foregoing description, and all changes which come within the meaning and range of equivalency of the claims are therefore intended to be embraced therein.

What is claimed is:

1. A level measurement apparatus for determining the level of a material in a container, said apparatus comprising:
an antenna for emitting energy pulses and coupling energy pulses reflected by the material;
a controller having a transmit module operably coupled to the antenna and a receiver module operably coupled to said antenna for receiving said coupled energy pulses;
said controller operating under the control of a program stored in memory, said memory being operably coupled to said controller;
said program comprising a plurality of code components including a code component for controlling said transmit module, a code component for controlling said receiver module and a code component for determining the level of the material based on said reflected pulses; and
a program update module for updating any one of said code components.

2. The level measurement apparatus as claimed in claim 1, wherein said program update module comprises a communication interface for receiving one or more code segments for updating the program stored in said memory and a code component for writing the code segment to the program stored in said memory.

3. The level measurement apparatus as claimed in claim 2, wherein said code segment comprises a header section and a code section, said header section including an address for locating said code segment in said program memory.

4. The level measurement apparatus as claimed in claim 3, wherein said header section further includes an identification field, said identification field including information identifying the code segment.

5. The level measurement apparatus as claimed in claim 4, wherein said header section further includes a revision field, said revision field-including revision data associated with said code segment.

6. The level measurement apparatus as claimed in claim 5, wherein said program update module includes a code component responsive to said revision data for determining if there are any other code segments related to said code segment being updated.

7. The level measurement apparatus as claimed in claim 4, wherein said header section includes a data field, said data field providing information about other of said code segments related to said code segment being updated.

8. The level measurement apparatus as claimed in claim 2, wherein said communication interface comprises a current loop interface for coupling to one port of a current loop, said current loop including another port for coupling to a remote device for downloading said code segment to said program update module.

9. A method for updating a code segment in a program stored in memory for a level measurement apparatus for determining the level of a material received in a container, the method comprises the steps of:
specifying a code segment to be updated;
formatting said specified code segment for downloading to the level measurement apparatus;
receiving said specified code segment at the level measurement apparatus;
determining a memory location for said specified code segment;
writing said specified code segment in the program at said memory location in the memory.

10. The method as claimed in claim 9, wherein said step of specifying a code segment for downloading comprises determining a revision number for at least one other code segment in the program and selecting said specified code segment based on said revision number.

11. The method as claimed in claim 10, wherein said step of formatting said specified code segment for downloading comprises assembling a code block having a header section and a code section, said header section including a field for storing a memory address for said specified code segment, and said code block comprising executable code.

12. The method as claimed in claim 11, wherein said step of determining a memory location is responsive to said memory address stored in the field in said header section.

13. The method as claimed in claim 11, wherein said header section includes a field for storing an identifier associated with said code segment.

14. The method as claimed in claim 9, further including the step of determining whether there is a prerequisite code segment associated with said specified code segment to be download, and downloading said prerequisite code segment prior to said specified code segment.
